(19) United States
(12) Patent Application Publication
(10) Pub. No.: US 2007/0162490 A1
(43) Pub. Date: Jul. 12, 2007

(54) SYSTEM AND METHOD FOR GENERATING A UNIFORM INDEXING SCHEME FOR ORDERING AND RETRIEVING PROPERTY INFORMATION

(75) Inventors: Christopher L. Rubio, Oceanside, CA (US); Mark A. Werner, Carlsbad, CA (US)

Correspondence Address: FIRST AMERICAN REAL ESTATE;c/o SNELL & WILMER, LLP, 600 ANTON BOULEVARD, SUITE 1400, COSTA MESA, CA, 92626, US

(73) Assignee: Data Tree, Inc., Santa Ana, CA (US)

(21) Appl. No.: 11/620,226

(22) Filed: Jan. 5, 2007

Related U.S. Application Data
(60) Provisional application No. 60/757,053, filed on Jan. 6, 2006.

(51) Int. Cl. G06F 7/00

(52) U.S. Cl. 707/102

(57) ABSTRACT

One embodiment of the invention provides a method of generating a document index using a document description including receiving a document description including a county identifier, a state identifier, a document identifier and a document type, searching a plurality of databases for a database identified by the county identifier and the state identifier, determining an indexing format for the database, and generating a document index in the indexing format using the document description.

### CLAIM OF PRIORITY UNDER 35 U.S.C. §119

The present Application for Patent claims priority to Provisional Application No. 60/757,053, filed on Jan. 6, 2006, and assigned to the assignee hereof and hereby expressly incorporated by reference herein.

### FIELD OF THE INVENTION

The invention relates generally to systems and methods for quickly and efficiently locating and obtaining information related to a property. More particularly, the invention relates to systems and methods for automating the ordering and retrieval of recorded land documents and images and providing property ownership and sales information.

### DESCRIPTION OF THE RELATED ART

The practice of recording real property transfers is well known. Local governments (e.g., counties) typically administer the recording system. When a property owner transfers an interest in his property, a document evidencing the transfer is recorded in the county where the property is located, thus providing notice to others of who owns the property. The property owner may transfer all his right, for example, when an individual sells his property, in which case a deed is usually recorded. In another example, a property owner may transfer only a right to foreclose on a mortgage if he does not make required payments, in which case a mortgage is usually recorded.

Before a buyer gives money to a seller in return for an interest in the property, the buyer needs to confirm that the seller owns the property and has the right to transfer the interest in the property. Title companies generally provide this confirmation in the form of “title policies.” An owner's title policy is an insurance policy that insures the buyer against the risk of receiving a defective interest in a property. Before issuing a title policy, a title company manually and physically searches recorded property records to create a chain of title and identify potential encumbrances to ensure proper transfer of the property. For example, a clerk at the county recorders office may examine title books to find recorded property records for a particular property. Likewise, before a lender lends money secured by property, the lender typically searches the recorded property records to assess the quality of the collateral. Such lenders may purchase a loan policy to insure the lender against the risks of making a loan on a property with potential title problems. These are, of course, but two examples of instances in which searching recorded property records is desirable, albeit probably the most common examples.

For a number of reasons, the process of searching property records is labor intensive and error prone. Property records typically are recorded in chronological order, not according to location, thus complicating the task of identifying recorded documents relating to a specific property from among thousands of recorded documents. Furthermore, any given property may be a subdivided portion of a larger property and the property descriptions of each property may not be consistent. In addition, a variety of documents may be used to record transfers of property interests, and a standard format does not exist. Errors in recorded documents or in the indexing used to locate the recorded documents may further compound the problem. Probably most importantly, however, is the lack of an electronic searching system that includes all the information an underwriter may need to know about a property before issuing a policy or approving a loan relating to the property.

One barrier to creating an electronic searching system is the lack of an efficient system for converting documents—in some cases, hundreds of thousands of documents—to searchable records. It is impractical to parse every legal description by hand, and property records have extremely complex language, making electronic parsing extremely difficult. Consider, for example, a legal description on a deed. Numerous formats exist for describing a property, and for every format there are multiple permutations for ordering the terms. Couple that with the possibility that personal names, subdivisions, and even cities and counties may have common words and the barrier to creating processes for efficiently populating a searchable database from property records becomes clear.

Another barrier to creating an electronic searching system is the large variety of documents used in different jurisdictions. Different counties and different states have different legal requirements and different customers, leading to different deeds, mortgages and the like. Furthermore, even within a common jurisdiction, different title companies and different lenders use different documents. The reality makes it difficult to efficiently extract data from so many potentially different documents.

### BRIEF DESCRIPTION OF THE DRAWINGS

FIG. 1 is a screen view of a graphical user interface (“GUI”) that allows a user to input a user name and a password prior to performing a search on a property according to one embodiment of the invention.

FIG. 2 is a screen view of a GUI that allows a user to search for a property by inputting an address according to one embodiment of the invention.

FIG. 3 is a screen view of the GUI of FIG. 2 that shows an example of an address that has been input into the street address field, the city field and the state field according to one embodiment of the invention.

FIG. 4 is a screen view of a GUI that displays a list of documents that can be ordered for the searched property and allows a user to order and retrieve these documents according to one embodiment of the invention.

FIG. 5 is a screen view of a GUI that allows a user to search for a property by inputting an owner name according to one embodiment of the invention.

FIG. 6 is a screen view of a GUI that allows a user to search for a property by inputting an assessors' parcel number according to one embodiment of the invention.

FIG. 7 is a screen view of a GUI that allows a user to search for a property by inputting a document identification code according to one embodiment of the invention.

FIG. 8 is a flow chart of an exemplary method of converting a document number to match the format of a predetermined indexing scheme according to one embodiment of the invention.

FIG. 9 is a flow chart of an exemplary method of submitting multiple searches for a property and receiving various documents in response to the search according to one embodiment of the invention.

FIG. 10 is a screen view of a GUI that allows a user to download a template for processing multiple searches for a property and upload a customer file to process multiple document requests according to one embodiment of the invention.

FIG. 11 is a screen view of a GUI that allows a user to order and download documents revealed from a search for a property according to one embodiment of the invention.

FIGS. 12A, 12B, and 13-15 are screen views of GUIs that allow a user to request abstractor services and help according to one embodiment of the invention.

FIG. 16 is a block diagram of a system for implementing the methods for generating a uniform indexing scheme for automating the ordering and retrieval of recorded land documents and images and providing property ownership and sales information according to various embodiments of the invention.

### SUMMARY

One embodiment of the invention provides a method of generating a document index using a document description including receiving a document description including a county identifier, a state identifier, a document identifier and a document type, searching a plurality of databases for a database identified by the county identifier and the state identifier, determining an indexing format for the database, and generating a document index in the indexing format using the document description.

One embodiment of the invention provides a computer-based method of generating a document index for each property document including searching for a property document using a property identifier, obtaining a document description related to the property document, and obtaining a county code from the document description or a database. The computer-based method further includes determining a document format for a database corresponding to the county code, and modifying the document description to comply with the document format to produce an index code.

One embodiment of the invention provides a computer-based method of receiving property information including receiving a property identifier for a subject property, retrieving a list of documents associated with the subject property, receiving a request for a document from the list of documents, the request including a document type and transmitting the document to a requestor.

One embodiment of the invention is an apparatus for generating a document index using a document description. The apparatus is configured to receive a document description including a county identifier, a state identifier, a document identifier and a document type, search a plurality of databases for a database including the county identifier and the state identifier, determine an indexing format for the database, and generate a document index in the indexing format using the document description.

### DETAILED DESCRIPTION

Systems and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements.

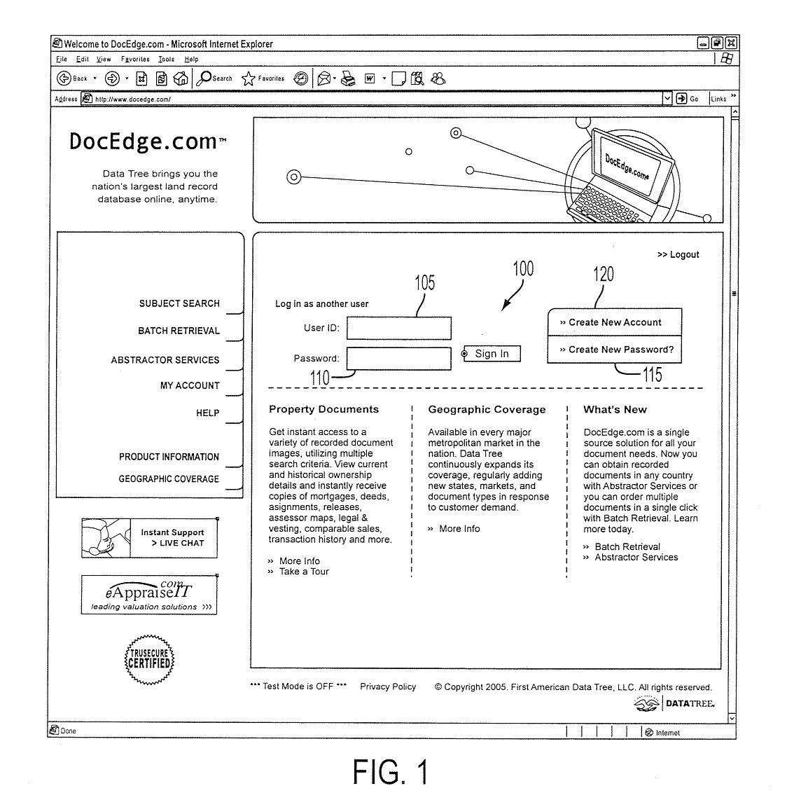

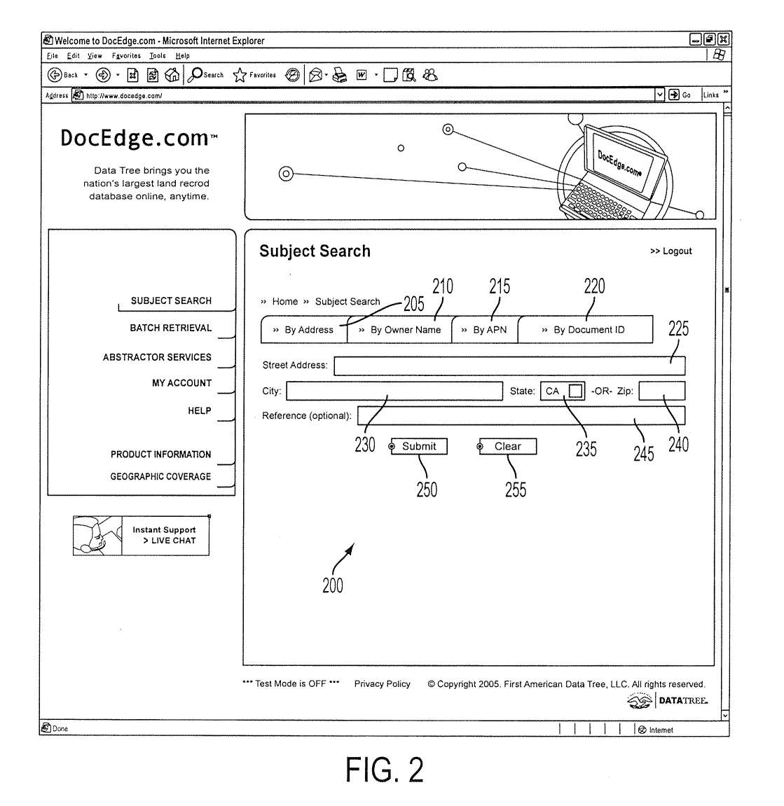

FIG. 1 is a screen view of a graphical user interface (“GUI”) 100 that allows a user to input a user name and a password prior to performing a search on a property according to one embodiment of the invention. The user name can be input into a user name field 105 and the password can be input into a password field 110. If the user forgets his password, the user can select a Forget Your Password? icon 115 to receive his password via email. If the user does not have an account, the user can select a Create New Account icon 120 to create a new account. Once the user correctly inputs the user name and the password, the screen view as shown in FIG. 2 is displayed.

FIG. 2 is a screen view of a GUI 200 that allows a user to search for a property by inputting an address according to one embodiment of the invention. The user can search for a specific property using several different search methods. For example, the GUI 200 allows the user to search for a specific property by address, by owner name, by APN and by document ID by selecting the appropriate tab, i.e., a By Address tab 205, a By Owner Name tab 210, a By APN tab 215 and a By Document ID tab 220. The By Address tab 205 is selected by default.

If the By Address tab 205 is selected, the GUI 200 may have a street address field 225, a city field 230, a state field 235, a zip code field 240, and a reference field 245. To locate a specific property, a user may input a street address into the street address field 225, and a name of a city into the city field 230, and select a name of a state for the state field 235 from a pull-down menu. Alternatively, the user may input a street address into the street address field 225 and a zip code into the zip code field 240 to locate a specific property. The user may optionally input a name of a reference into the reference field 245. The reference field 245 allows to user to input a comment. Once the information is input, the user may select a submit button 250 to perform the search. If the input information needs to be cleared, the user may select a clear button 255 to clear the information contained in all the fields.

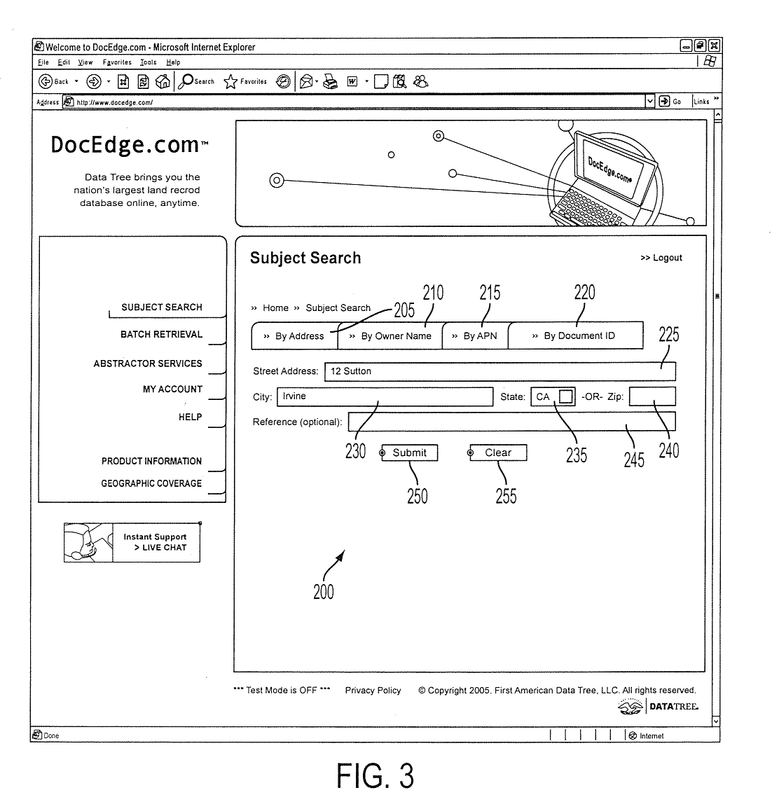

FIG. 3 is a screen view of the GUI 200 that shows an example of an address that has been input into the street address field 225, the city field 230 and the state field 235 according to one embodiment of the invention. As shown in FIG. 3, the user has input a street address of “12 Sutton,” a city of “Irvine” and a state of “CA.” Once the address is input, the user may select the submit button 250 to perform the search on the specific property.

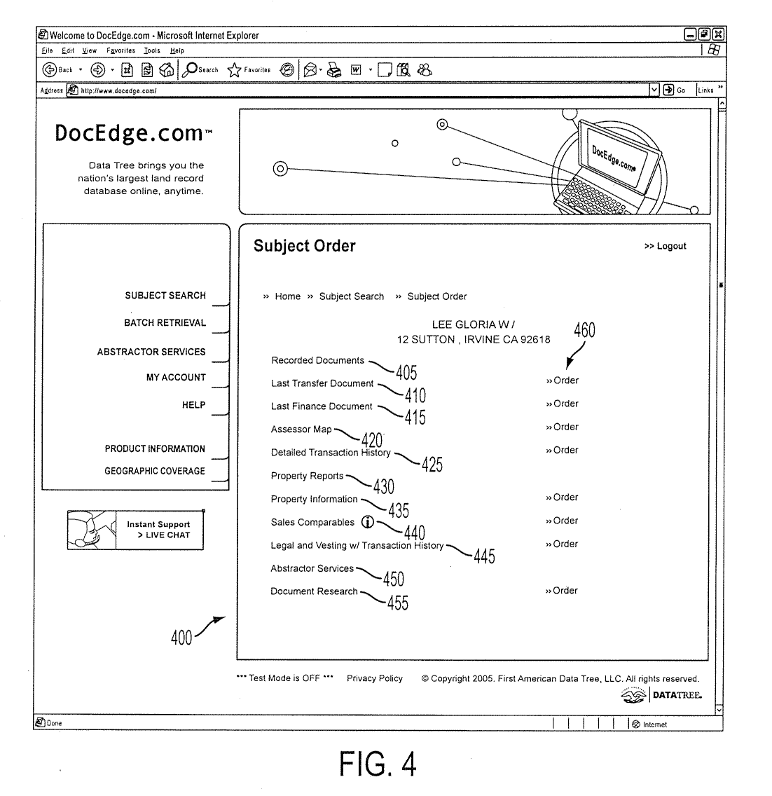

FIG. 4 is a screen view of a GUI 400 that displays a list of documents that can be ordered for the searched property and allows a user to order and retrieve these documents according to one embodiment of the invention. The list of documents that can be retrieved may be obtained from a database, for example, property document database 1615 containing information from the county recorder's office where the searched property is located. The name of the property owner along with the address is shown at the top of the screen view. The GUI 400 provides a list of documents that can be ordered for the property identified from the search. For example, the recorded documents 405 may include a last transfer document 410, a last finance document 415, an assessor map 420, and a detailed transaction history 425. The property reports 430 may include property information 435, sales comparables 440, and legal and vesting title with transaction history 445. The abstractor services 450 may include document research 455. Any of these documents and services can be ordered by selecting an Order link 460 adjacent to the desired document or service.

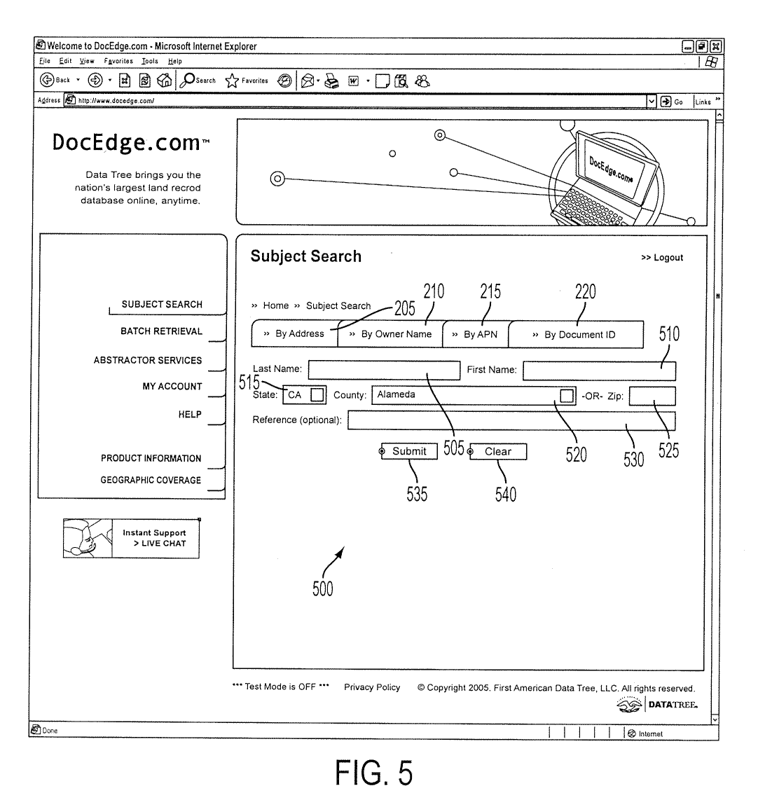

If the By Owner Name tab 210 is selected, FIG. 5 is displayed. FIG. 5 is a screen view of a GUI 500 for allowing a user to search for a property by inputting an owner name according to one embodiment of the invention. The GUI 500 may have a last name field 505, a first name field 510, a state field 515, a county field 520, a zip code field 525, and a reference field 530. To locate a specific property, a user may input a last name into the last name field 505, and a first name into the first name field 510, and select a name of a state for the state field 515 from a pull-down menu and a county in the state for the county field 520 from a pull-down menu. Alternatively, the user may input a last name into the last name field 505 and a first name into the first name field 510 and a zip code into the zip code field 525 to locate a specific property. The user may optionally input a name of a reference into the reference field 530. Once the information is input, the user may select a submit button 535 to perform the search. If the input information needs to be cleared, the user may select a clear button 540 to clear the information contained in all the fields.

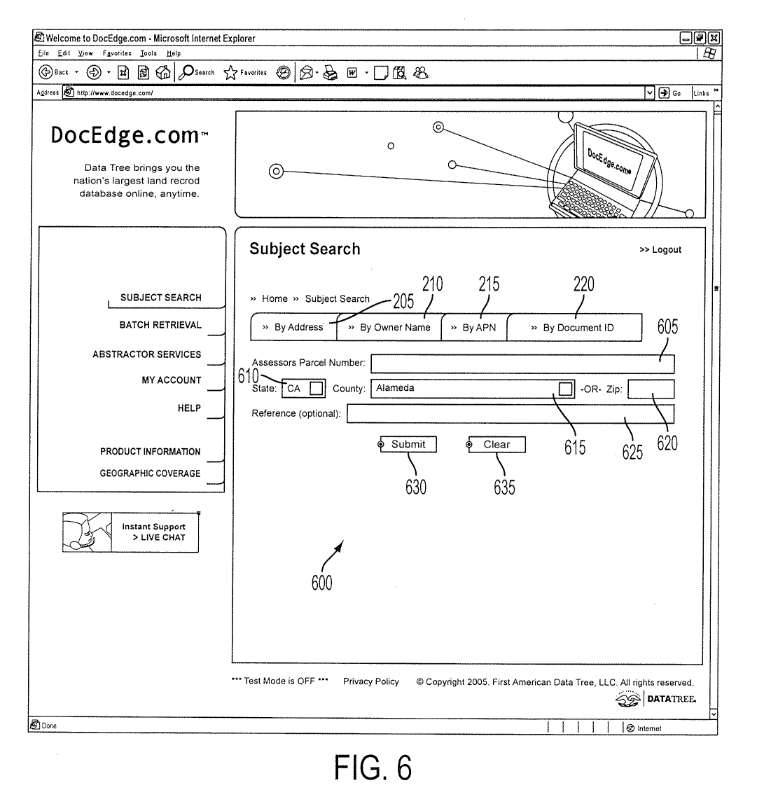

If the By APN tab 215 is selected, FIG. 6 is displayed. FIG. 6 is a screen view of a GUI 600 that allows a user to search for a property by inputting an assessor's parcel number according to one embodiment of the invention. The GUI 600 may have an assessors parcel number field 605, a state field 610, a county field 615, a zip code field 620, and a reference field 625. To locate a specific property, a user may input an assessors' parcel number into the assessors parcel number field 605, and select a name of a state for the state field 610 from a pull-down menu and a county in the state for the county field 615 from a pull-down menu. Alternatively, the user may input an assessors' parcel number into the assessors parcel number field 605 and a zip code into the zip code field 620 to locate a specific property. The user may optionally input a name of a reference into the reference field 625. Once the information is input, the user may select a submit button 630 to perform the search. If the input information needs to be cleared, the user may select a clear button 635 to clear the information contained in all the fields.

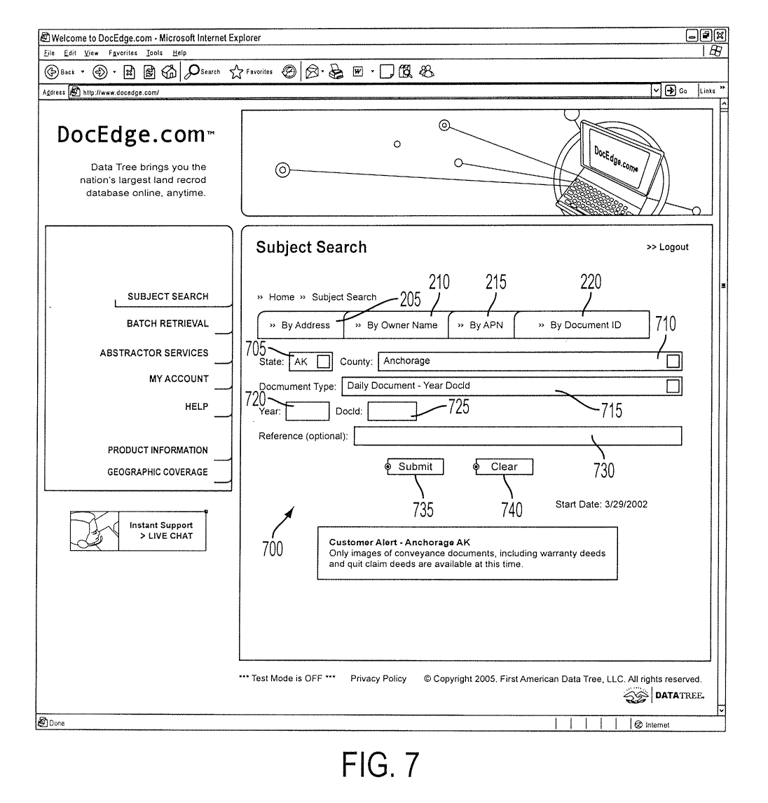

If the By Document ID tab 220 is selected, FIG. 7 is displayed. FIG. 7 is a screen view of a GUI 700 that allows a user to search for a property by inputting a document identification code according to one embodiment of the invention. The GUI 700 may have a state field 705, a county field 710, a document type field 715, a year field 720, a document ID field 725, and a reference field 730. To locate a specific property, a user may select a name of a state for the state field 705 from a pull-down menu, a county in the state for the county field 710 from a pull-down menu, and a document type from the document type field 715. Some examples of the document type include (1) Assessment Map, (2) Assessor Map, (3) Daily Document—Book Page (Pre-6/30/2001), (4) Daily Document—Year DocID, (5) Parcel Map, (6) Record Map, and (7) Tract Map. Additionally, the user may input a year of the document in the year field 720 and a document ID or number in the document ID field 725. The user may optionally input a name of a reference into the reference field 730. Once the information is input, the user may select a submit button 735 to perform the search. If the input information needs to be cleared, the user may select a clear button 740 to clear the information contained in all the fields.

Once the search is performed, the user at the client device 1605 may want to download a particular document from one of the property documents databases 1615. Each document requested may have a different document description (i.e., a unique document description) because it has been obtained from a different county. Furthermore, each document description may have a different format because each county may use a different formatting scheme to record and identify its documents. Therefore, the document description may be more efficiently utilized if it is converted to a uniform document number or predetermined indexing scheme.

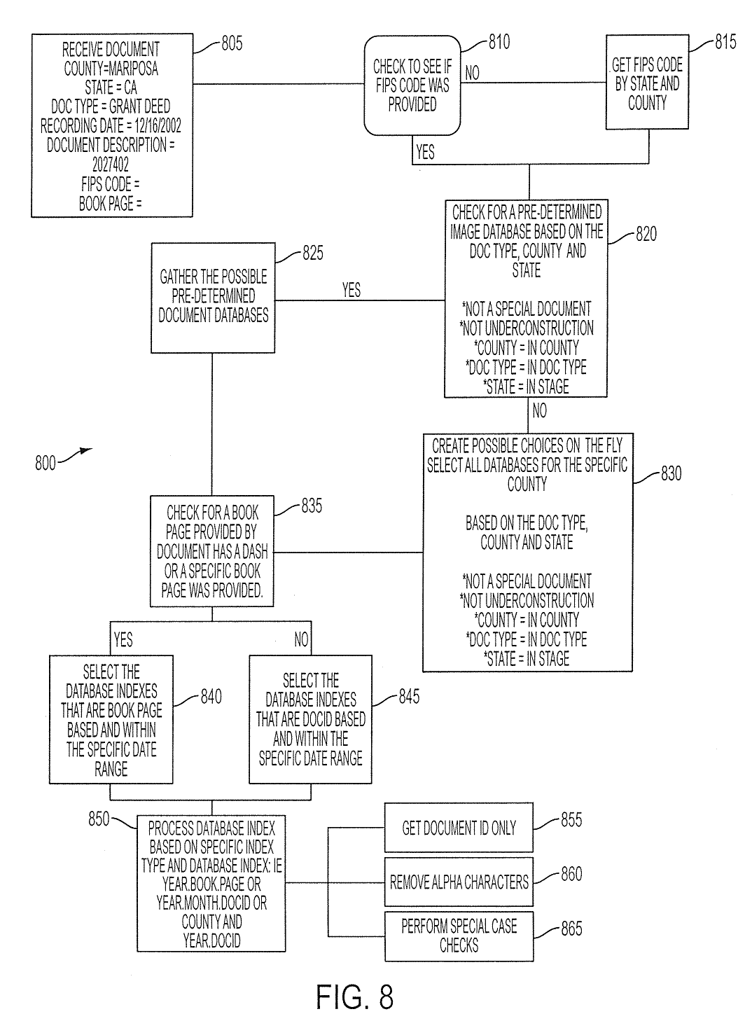

FIG. 8 is a flow chart 800 of an exemplary method of converting a document description to match the format of a predetermined indexing scheme according to one embodiment of the invention. The method can be implemented in hardware, software, or a combination of hardware and software using a personal computer, server, or other processor based system. At step 805, the processing module 1610 receives a document description related to a document requested by the user. For example, when the user selects an Order link 460 (FIG. 4) for a particular document, the processing module 1610 receives a document description related to the ordered document from a third party or a property documents database 1615. The document description may include a county name, a state name, a document type, a recording date, a document description (e.g., a code or number), a fips code (i.e., a number or code identifying a county and a state) and book and page numbers. The book and page numbers identify the book and page(s) in the county book located at the county office on which the document can be found.

Once the document description is received, the processing module 1610 determines whether the document description includes a fips code (step 810). If a fips code is not included in the document description, then the processing module 1610 requests or retrieves a fips code using the state name and the county name from a database 1615 (step 815). Each county has a unique fips code.

The processing module 1610 may retrieve information from a number of databases 1615. Each database 1615 may include information (e.g., documents, images, maps, etc.) pertaining to a specific state, county and document type. For example, one database 1615 may be dedicated to the state of California, county of Orange, and grant deed documents. At step 820, the processing module 1610 searches the number of databases 1615 for a database dedicated to, for example, the state of California, county of Orange, and grant deed documents. The processing module 1610 may also use other information (e.g., the recording year) in the document description to locate the correct database. In some instances, the processing module 1610 may identify more than one database that meets the criteria specified in the document description (step 825). If the processing module 1610 does not find a database 1615 dedicated to the state, county and document type specified in the document description, the processing module 1610 performs a broader search of the number of databases for a database dedicated to, for example, the state of California and the county of Orange.

Once the database(s) has been identified, the processing module 1610 determines whether the document description includes a book number and a page number (step 835). If the document description includes a book number and a page number, then the processing module 1610 selects the database that is book and page number based and within the specific date range of the recording date (step 840). If the document description does not include a book number and a page number, then the processing module 1610 selects the database that is doc ID based and within the specific date range of the recording date (step 845).

At step 850, the processing module 1610 checks the format of the selected database and modifies the document description to comply with the format in the database. The modified description may be referred to as an index code. In one embodiment, the index code may include a CMT (county, method, type) index and a formatted document description. For example, the CMT index of 355 corresponds to county=San Diego, method=Year.DocID and type=grant deed. An example of a formatted document description can be 2004.1234. A unique index code may be generated for each document description. The index code allows quick, efficient and accurate searching of documents.

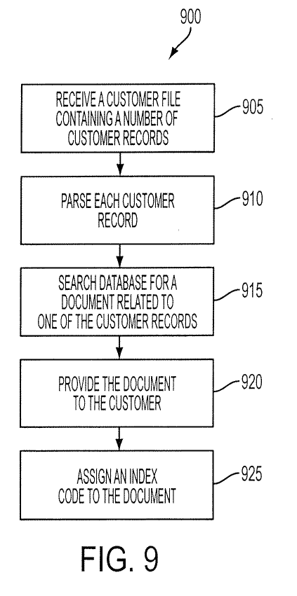

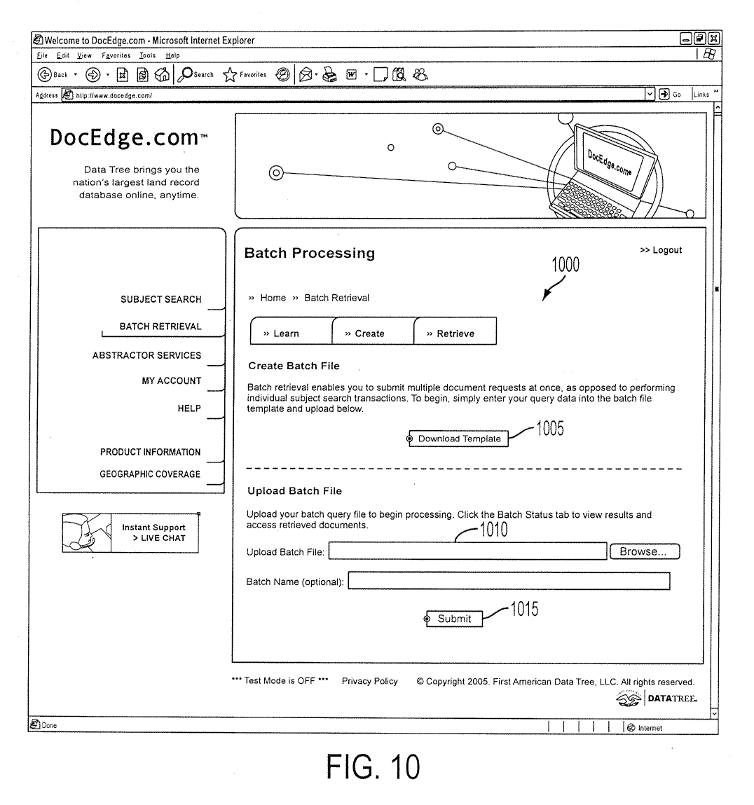

FIG. 9 is a flow chart 900 of an exemplary method of submitting multiple searches for a property and receiving various documents in response to the search according to one embodiment of the invention. For example, the user is able to submit multiple addresses to the processing module 1610 for automated searches. At step 905, the processing module 1610 imports or receives a customer file containing a number of customer records. The user can download a template by selecting a download template button 1005 (see FIG. 10).

FIG. 10 is a screen view of a GUI that allows a user to download a template for processing multiple searches for a property and upload a customer file to process multiple document requests according to one embodiment of the invention. The customer file can be created by inputting the customer records into the template. Once the customer file is created or imported, the file can be uploaded by inputting the file name into a batch file field 1010 and selecting a submit button 1015. In one embodiment, the customer records can be maintained in a spreadsheet (e.g., Excel) file. The spreadsheet file may have a predefined spreadsheet file format. The customer file may be received from a third party or retrieved from a database or memory and stored locally with the processing module 1610.

At step 910 of FIG. 9, the processing module 1610 parses each customer record to identify or separate the information contained therein. For example, each customer record may include property characteristics such as an owner name, an APN, a street address, a city, a county, a state, a zip code, and a document request (e.g., all documents with a certain finance amount, last finance documents, all finance documents, last sale documents, all documents, etc.). The parsing allows the processor the ability to define what property characteristics are to be used to search for the property. Based on one or more of the property characteristics, the processing module 1610 searches a database 1615 to determine if the document requested is in the database (step 915). The database 1615 generally includes documents that have been obtained from various counties throughout the United States. For each customer record within the customer file a property search may be performed using different search methods (e.g., By Address, By Owner Name, By APN or By Document ID).

In one embodiment, the database 1615 enables those zip codes that correspond to documents that are in the database 1615. The processing module 1610 checks whether the zip code on the customer record is one of the enabled zip codes in the database 1615. If the customer record does not include a zip code, the processing module 1610 accesses a look-up table and locates the zip code on the table using the city and state. The processing module 1610 can perform many different searches based on a number of different criteria. For example, the customer record can include (1) the street address, the city, and the state, (2) the street address and the zip code, (3) the owner name, the county, and the state, (4) the owner name and the zip code, (5) the APN, the county and the state, or (6) the APN and the zip code. For each of the above search methods, if no results are obtained, the research may be performed again using another search method. If the customer record does not contain the criteria that will enable a successful search then the customer record is rejected. If multiple documents are obtained, the processing module 1610 may check the customer record to identify the correct document.

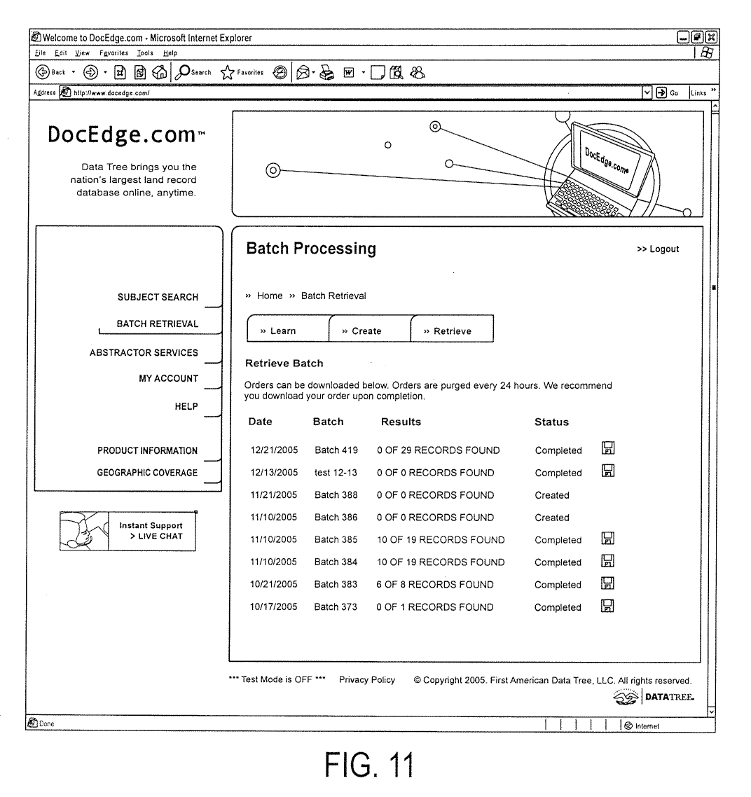

If the search is successful, then the document may be provided to the user and the document description may be stored in a database (step 920). The document description may be converted into an index code as discussed in FIG. 8 (step 925). Once the search is complete, the user receives the completed search results, for example, the found property description and images (see FIG. 11).

FIG. 11 is a screen view of a GUI that allows a user to order and download documents revealed from a search for a property according to one embodiment of the invention. The user may order and download the document based on the index code. The Retrieve tab may be selected to order and download the document.

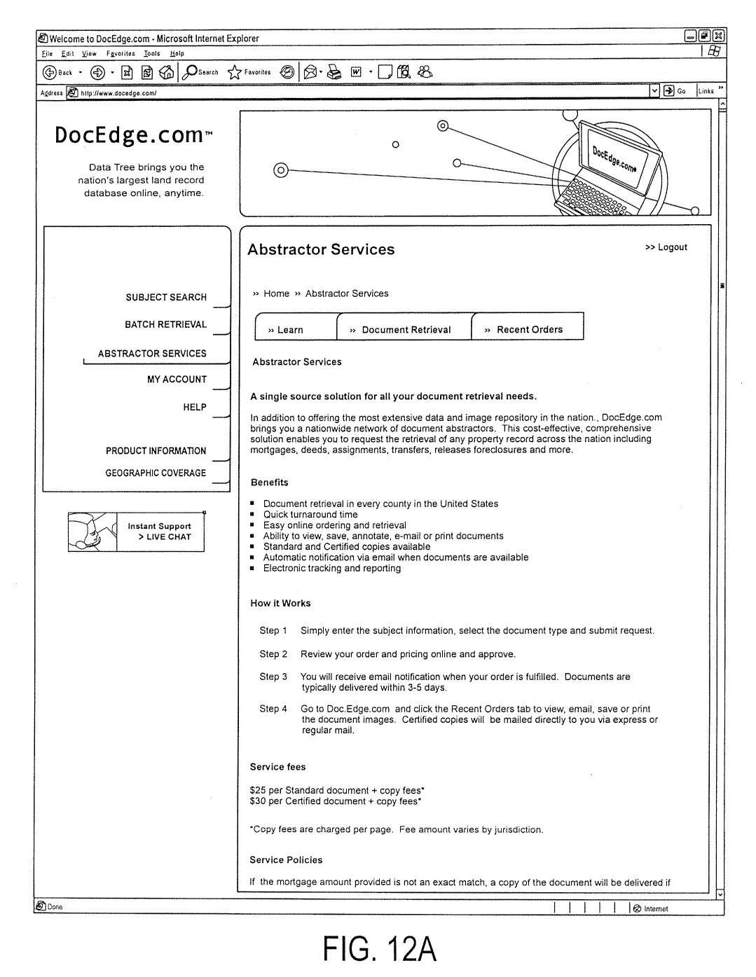

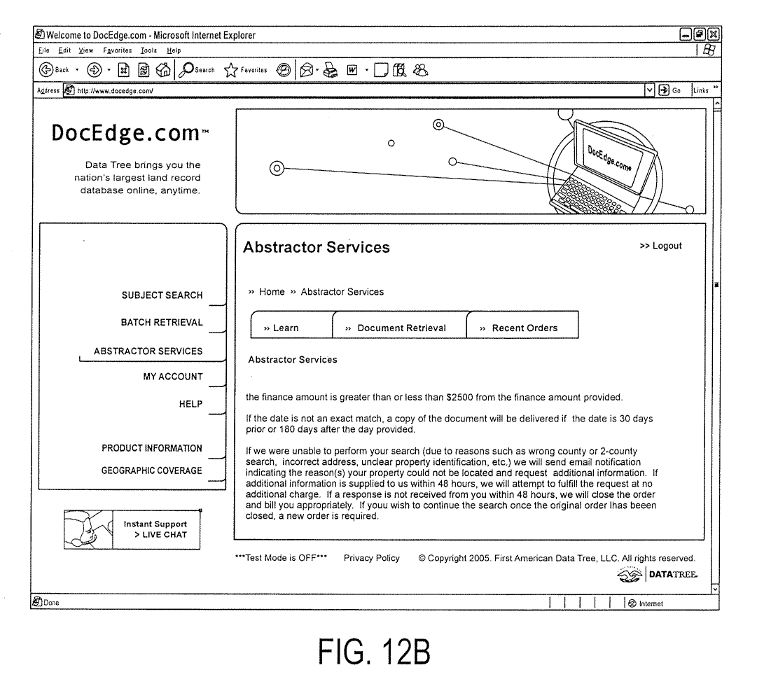

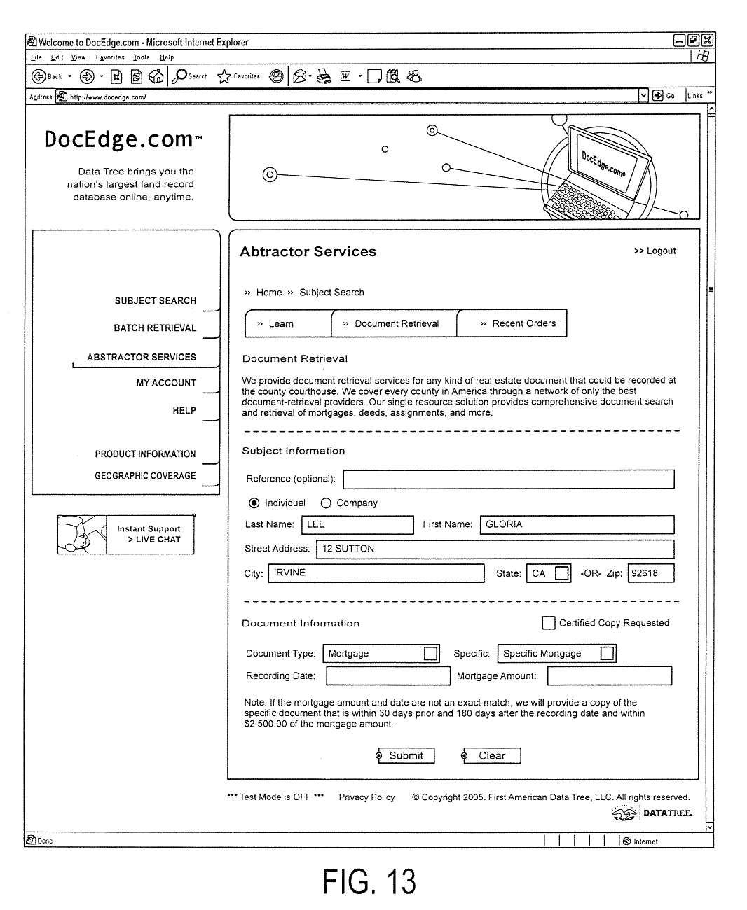

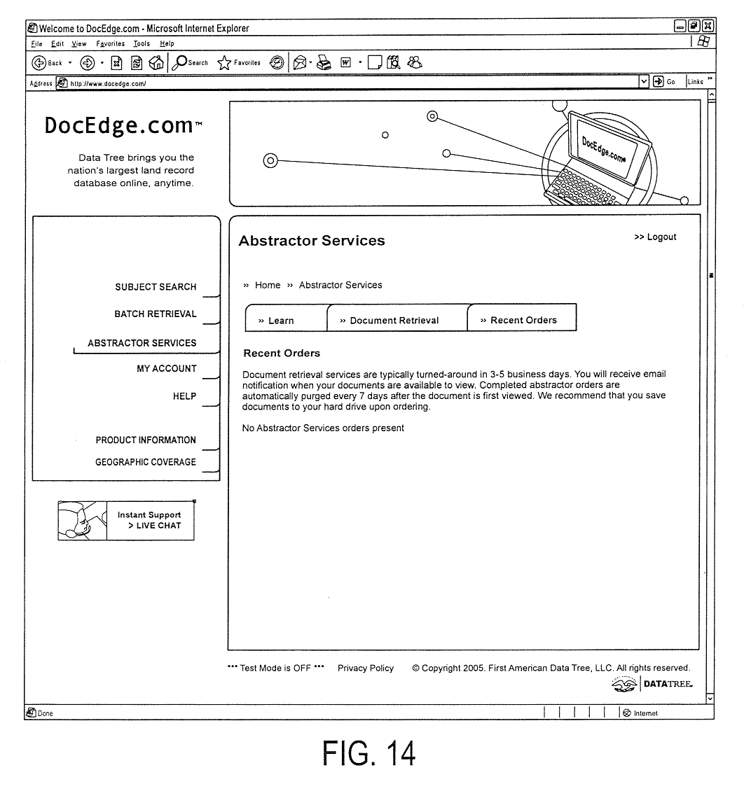

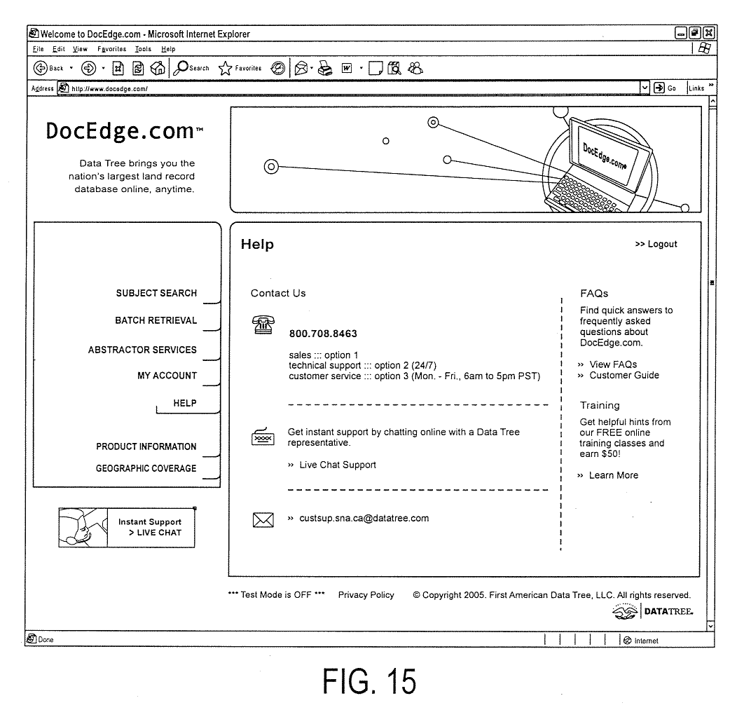

FIGS. 12A, 12B, and 13-15 are screen views of GUIs that allow a user to request abstractor services and help according to one embodiment of the invention. FIGS. 12A and 12B describe Abstractor Services such as document retrieval in every county in the United States, quick turnaround time, easy online ordering and retrieval, ability to view, save, annotate, e-mail or print documents, ability for standard and certified copies, automatic notification via email when documents are available, and electronic tracking and reporting of documents. To use the abstractor services, the user of the client device 1605 enters the subject information and document information and submits the request (FIG. 13). The recent orders are displayed on FIG. 14. If the user needs help, the help tab can be selected and FIG. 15 is displayed to provide the user with different ways of getting help.

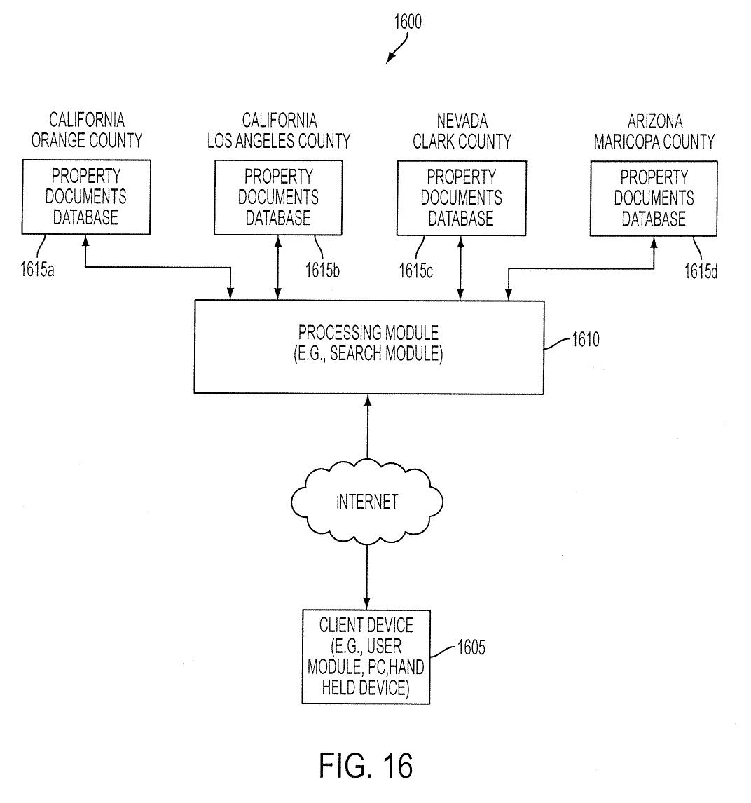

FIG. 16 is a block diagram of a system 1600 for implementing the methods for generating a uniform indexing scheme for automating the ordering and retrieval of recorded land documents and images and providing property ownership and sales information according to various embodiments of the invention. The system 1600 may include a client device 1605 (e.g., a user module, a PC, a handheld device, cell phone, etc.), a processing module 1610, and one or more databases 1615. The processing module 1610 may be a processor, a controller, a control system, or other processing device. Each database may be located at the specific county office or at a central location. Each database may contain property documents (e.g., recorded property documents) pertaining to properties located within a specific county or state. One database may be used for multiple states. The client device 1605, the processing module 1610, and the databases 1615 may be implemented using hardware, software, or combinations thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A computer-based method of generating a document index using a document description comprising:
receiving a document description including a county identifier, a state identifier, a document identifier and a document type;
searching a plurality of databases for a database including the county identifier and the state identifier;
determining an indexing format for the database; and
generating a document index in the indexing format using the document description.

2. The method of claim 1 wherein the document description corresponds to the document.

3. The method of claim 1 further comprising:
receiving a property identifier;
performing a search for a property identified by the property identifier; and
receiving a document related to the property.

4. The method of claim 3 wherein the property identifier is selected from a group consisting of an address, an owner name, an assessors parcel number and a document identification code.

5. A computer-based method of generating a document index for each property document comprising:
searching for a property document using a property identifier;
obtaining a document description related to the property document;
obtaining a county code from the document description or a database;
determining a document format for a database corresponding to the county code; and
modifying the document description to comply with the document format to produce an index code.

6. The method of claim 5 wherein the property identifier is selected from a group consisting of an address, an owner name, an assessors parcel number and a document identification code.

7. The method of claim 5 wherein the document description is selected from a group consisting of a county name, a state name, a document type, a recording date, a document description, a fips code, a book number, and a page number.

8. The method of claim 5 wherein the county code is a fips code.

9. The method of claim 5 further comprising retrieving a list of documents associated with the property identifier.

10. A computer-based method of receiving property information comprising:
receiving a property identifier for a subject property;
retrieving a list of documents associated with the subject property;
receiving a request for a document from the list of documents, the request including a document type; and
transmitting the document to a requestor.

11. The method of claim 10 wherein the property identifier is selected from a group consisting of an address, an owner name, an assessors parcel number and a document identification code.

12. The method of claim 10 wherein the list of documents include recorded documents and property reports.

13. The method of claim 12 wherein the recorded documents include a last transfer document, a last finance document, an assessor map and a detailed transaction history.

14. The method of claim 12 wherein the property reports include property information, sales comparables and a legal and vesting title with transaction history.

15. The method of claim 10 wherein the document type is selected from a group consisting of an assessment map, an assessor map, a book page, a year document identification, a parcel map, a record map and a tract map.

16. An apparatus for generating a document index using a document description, the apparatus configured to:
receive a document description including a county identifier, a state identifier, a document identifier and a document type;
search a plurality of databases for a database including the county identifier and the state identifier;
determine an indexing format for the database; and
generate a document index in the indexing format using the document description.

17. The apparatus of claim 16 wherein the document description corresponds to the document.

18. The apparatus of claim 16 further configured to:
receive a property identifier;
perform a search for a property identified by the property identifier; and
receive a document related to the property.

19. The apparatus of claim 18 wherein the property identifier is selected from a group consisting of an address, an owner name, an assessors parcel number and a document identification code.

20. The apparatus of claim 16 wherein the document index includes a CMT (county, method, type) index and a formatted document description.
